(19) United States
(12) Patent Application Publication
(10) Pub. No.: US 2016/0212604 A1
(43) Pub. Date: Jul. 21, 2016

(54) EARLY-WARNING SYSTEM FOR DISASTERS

(71) Applicant: HSIANG-FONG TSAI, TAIPEI CITY 110 (TW)

(72) Inventor: HSIANG-FONG TSAI, TAIPEI CITY 110 (TW)

(21) Appl. No.: 15/000,681

(22) Filed: Jan. 19, 2016

(30) Foreign Application Priority Data
Jan. 19, 2015 (TW) 104101713

(51) Int. Cl. H04W 4/22; H04W 84/18; H04W 4/08; H04W 4/02

(52) U.S. Cl. CPC H04W 4/22; H04W 4/023; H04W 84/18; H04W 4/08

(57) ABSTRACT

An early-warning system for disasters includes at least one sensor unit, a person-position detection module, a primary control module and a warning module. The system utilizes various sensor units, a Bluetooth communication module and a wireless network communication module and the like person-position detection module to detect and thus generate at least four disaster-sign factors. According to pre-disaster alert classification rules in algorithms tables, a plurality of indexes and a plurality of pre-disaster alert classes can be obtained so as to transmit pre-disaster-management reminder information corresponding to the judged pre-disaster alert class to the warning module, and so people can be alerted verbally, lightly or in a wording manner and thus prepared in time prior to an occurrence of a disaster.

This application claims the benefit of Taiwan Patent Application Serial No. 104101713, filed Jan. 19, 2015, the subject matter of which is incorporated herein by reference.

### BACKGROUND OF INVENTION

1. Field of the Invention

The invention relates to an early-warning system for disasters, and more particularly to the early-warning system for disasters that introduces disaster-sign factors to determine the disaster class and the pre-disaster-management regime and further to provide users the pre-disaster-management reminder information.

2. Description of the Prior Art

Generally speaking, versatile gas detectors and fire alarms are usually seen indoors and outdoors in lots of private and/or public buildings, mainly for generating alarms to alert people while in meeting a gas leak or a fire. However, while the gas detector or the fire alarm detects a gas leak or fire smokes, it is a usual case that the gas leak and/or the fire have been there for a while. In addition, while hearing the alarm, people usually panic, but not calm down, in handling the necessary escape. Thereupon, precious time for managing the disaster and for the escape is usually missed, and thus plenty loss in properties and lives is inevitable.

### SUMMARY OF THE INVENTION

In view of the aforesaid prior art, since current gas detectors and fire alarms are mainly to detect the gas or the fire smoke so as further to determine if meeting a gas leak or a fire, thus an inevitable delay in confirming the gas leak and the fire exists before the gas detector and the fire alarm can detect the gas leak and the fire. Further, while people in hearing the alarm, panics prevail to fail people in handling the escape calmly. Sadly, loss due to the disaster is inevitable.

Accordingly, it is the primary object of the present invention to provide an early-warning system for disasters, which utilizes sensor units and position-detecting elements to detect disaster-sign factors, further to calculate corresponding disaster precautious classes and pre-disaster-management regimes, and thereby to provide the corresponding pre-disaster-management reminder information, so that people can manage responses prior to an occurrence of a disaster or to avoid the disaster.

In the present invention, the early-warning system for disasters includes at least one sensor unit, a person-position detection module, a primary control module and a warning module.

The sensor unit is to detect at least one disaster-sign factor within a controlled space, and the person-position detection module is to detect a user and then to generate a user position.

The primary control module, connected communicatively with the sensor unit and the person-position detection module, further includes a disaster classification database, a disaster response database and a management unit. The disaster classification database bases on the disaster-sign factor to set up at least one pre-disaster alert classification rule, and further bases on the pre-disaster alert classification rule to define at least one pre-disaster-management regime. The disaster response database is to store at least pre-disaster-management reminder information corresponding to the pre-disaster alert classification rule and the pre-disaster-management regime. The management unit, electrically coupled with the disaster classification database and the disaster response database, is to issue an alert signal including the pre-disaster-management reminder information after the user position is judged to be within the pre-disaster-management regime.

The warning module is connected communicatively with the management unit so as to receive the alert signal and further to broadcast the pre-disaster-management reminder information.

In the present invention, since the primary control module would apply the disaster-sign factors to determine the alert class and the pre-disaster-management regime prior to an occurrence of a disaster, so corresponding pre-disaster-management reminder information can be provided to the users in time so as to early manage the possible disaster.

In one embodiment of the present invention, the disaster response database further stores positions of at least one disaster reduction tool. Preferably, the disaster-management reminder information further includes the positions of at least one disaster reduction tool.

In one embodiment of the present invention, the person-position detection module is a human-body infrared sensor for determining the user position by infrared-detecting a body temperature of the user.

In one embodiment of the present invention, the person-position detection module is a wireless transmission module for detecting the user position of the user having a handheld device via a communicative positioning technique. The wireless transmission module can include a Bluetooth unit for detecting the user position of the user having the handheld device. In addition, the wireless transmission module can include a wireless network transmission unit connected communicatively with a server for detecting the user position of the user having the handheld device via a cellular-phone positioning technique. The wireless transmission module is to transmit the alert signal to the server, and the server transmits the alert signal to the handheld device so as to broadcast the pre-disaster-management reminder information in a word message manner.

In one embodiment of the present invention, the warning module further includes a warning message unit for broadcasting verbally the pre-disaster-management reminder information.

In one embodiment of the present invention, the pre-disaster-management reminder information further includes management time limits of pre-disaster alert class.

All these objects are achieved by the early-warning system for disasters described below.

### BRIEF DESCRIPTION OF THE DRAWINGS

The present invention will now be specified with reference to its preferred embodiment illustrated in the drawings, in which:

FIG. 1 is a schematic view of a preferred embodiment of the early-warning system for disasters in accordance with the present invention;

FIG. 2 demonstrates schematically the controlled space of the early-warning system for disasters for locating a user in accordance with the present invention; and

FIG. 3 demonstrates schematically a display screen of a handheld device that shows the instant disaster-management reminder information.

### DESCRIPTION OF THE PREFERRED EMBODIMENT

The invention disclosed herein is directed to an early-warning system for disasters. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

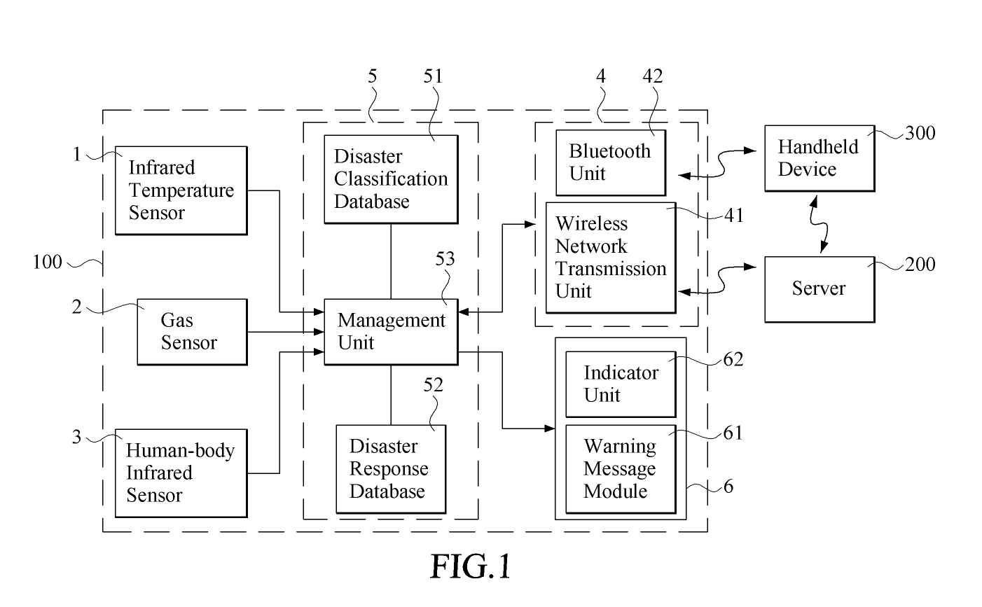

Referring now to FIG. 1, a schematic view of a preferred embodiment of the early-warning system for disasters in accordance with the present invention is shown. The early-warning system for disasters 100 includes an infrared temperature sensor 1, a gas sensor 2, a human-body infrared sensor 3, a wireless transmission module 4, a primary control module 5 and a warning module 6.

The infrared temperature sensor 1 is to perform detection upon a controlled space (not shown in the figure) so as particularly to obtain an indoor environmental temperature of the controlled space.

The gas sensor 2 is also to perform detection upon the controlled space so as particularly to obtain an indoor harmful gas concentration value of the controlled space.

The human-body infrared sensor 3 utilizes the infrared to detect user's body temperature so as further to determine the corresponding user position. Practically, the human-body infrared sensor 3 is an electronic device to detect movements of a human body, and is mainly to sense the infrared emitted by the warm human body so as to confirm the exact position of the user.

The wireless transmission module 4 applies the communicative positioning technique to obtain the instant position of a user of a handheld device 300, and includes a wireless network transmission unit 41 and a Bluetooth unit 42. The wireless network transmission unit 41 is connected communicatively with a server 200, and the server 200 is to detect the position of the user of the handheld device 300 via a cellular-phone positioning technique.

In the present invention, the aforesaid human-body infrared sensor 3 and wireless transmission module 4 are both introduced to detect the user position. However, in some other embodiments, the wireless transmission module 4 can use the wireless network transmission unit 41 to perform a long-range cellular-phone positioning technique such as a global positioning system (GPS) to locate the user position of the handheld device 300, or can (but not limited to) apply a nearby Bluetooth technique to locate the user position of the handheld device 300. In addition, the radio frequency (RF) technique and the like can be used to locate the user position of the handheld device 300.

The primary control module 5 is connected communicatively with the infrared temperature sensor 1, the gas sensor 2, the human-body infrared sensor 3, the wireless network transmission unit 41 and the Bluetooth unit 42. Further, the primary control module 5 can include a disaster classification database 51, a disaster response database 52 and a management unit 53.

The disaster classification database 51 bases on a plurality of disaster-sign factors to set up a plurality of pre-disaster alert classification rules, and bases on these pre-disaster alert classification rules to define a plurality of pre-disaster-management regimes, in which the pre-disaster-management regime for the fire is a 5-meter radial range of a fire's hi-risk point, and that for the gas leak is a 10-meter radial range of a gas leak point. In this embodiment, the pre-disaster alert classification rules can be referred to the following table.

Algorithms Table for Pre-Disaster Alert Classification Rules:

| | | Index 1 | Index 2 | Index 3 | Index 4 |
|---|---|---|---|---|---|
| Disaster- | User | In situ | Position ≦ | Position > | Position > |
| sign | Position | | Radius | Radius | Critical |
| factor | P | | r1 | r1 | value rt |
| | Occurrence | ≧ Alert | ≧ Alert | ≧ Critical | |
| | Time | value e1 | value e2 | value et | |
| | E | | | | |
| | Harmful | ≧ Alert | ≧ Alert | ≧ Critical | |
| | Gas | value g1 | value g1 | value gt | |
| | G | | | | |
| | Indoor | ≧ Alert | ≧ Alert | ≧ Critical | |
| | Temperature | value t1 | value t1 | value tt | |
| | T | | | | |

As described above, an algorithms table for combinations of user positions and gases of the disaster-sign factors and an algorithm table for combinations of user positions, occurrence times and indoor temperatures of the disaster-sign factors are listed as follows.

Algorithms Table for Combinations of User positions and Gases:

| | Precautious class | | | |
|---|---|---|---|---|
| Harmful | Alert | Low | Medium | Critical |
| gas G | class | warning class | warning class | class |
| Index 1 | P1 | P2 | P3, P4 | |
| Index 2 | P1 | | P2 | P3, P4 |
| Index 3 | P1 | | | P2, P3, P4 |

The foregoing algorithms table for combinations of user positions and harmful gases tells that, when the harmful gases are classified into three indexes (G1, G2 and G3) according to the rules in the algorithms table for pre-disaster alert classification rules, the precautious class corresponding to the user position can be located. For example, when the user position is “In situ” (i.e. P1) corresponding to three harmful gases (G1, G2 and G3), then all these harmful gases (G1, G2 and G3) belong to the alert class. Namely, no matter what the harmful gas is, ≧Alert value gl or ≧Critical value gt, it belongs to the alert class only if its user position is P1.

Algorithms Table for Combinations of User Positions,
Occurrence Times and Indoor Temperatures:

| | Precautious class | | | |
|---|---|---|---|---|
| Indoor | Alert | Low | Medium | Critical |
| Temperature T | class | warning class | warning class | class |
| Index 1 | P1 | P2 + E1~E2 | P2 + E3, | P3 + E3, P4 |
| | | | P3 + E1~E2 | |
| Index 2 | P1 | P2 + E1 | P2 + E2~E3 | P3, P4 |
| Index 3 | P1 | | P2 | P3, P4 |

In this table, the indoor temperatures are classified into three indexes T1, T2 and T3 according to the pre-disaster alert classification rules. For example, when the indoor temperature is T1, the user position is P2 (Position≦Radius r1), and the occurrence time is E1 (≧Alert value e1) or E2 (≧Alert value e2), then the precautious class is the low warning class.

The disaster response database 52, corresponding to the pre-disaster alert classification rules and the pre-disaster-management regimes, stores a plurality of pre-disaster-management reminder information and a plurality of positions of disaster reduction tools. In addition, the pre-disaster-management reminder information further includes management time limits for corresponding pre-disaster alert classes. For example, the management time limit for a fire is 5 minutes, and it implies that the fire should be handled in 5 minutes so as to avoid a further fire.

The management unit 53 is electrically coupled with the disaster classification database 51 and the disaster response database 52, and issues an alert signal containing the pre-disaster-management reminder information and the position of the disaster reduction tool when the human-body infrared sensor 3 detects that the user position is located within the pre-disaster-management regime. In practice, the management unit 53 can be a central processor.

As described above, the wireless network transmission unit 41 would receive the alert signal from the management unit 53, and forwards the alert signal to the handheld device 300 via the server 200 in a form of word message, such that the pre-disaster-management reminder information and the position of the disaster reduction tool can be displayed on the handheld device 300.

The warning module 6 is communicatively connected with the management unit 53, and further includes a warning message unit 61 and an indicator unit 62. The warning message unit 61 is to receive the alert signal and then to broadcast verbally the disaster-management reminder information. The indicator unit 62 displays the disaster-management reminder information after receiving the alert signal. In this embodiment, the warning message unit 61 is a speaker for broadcasting verbally the alert signal.

As described above, since the early-warning system for disasters 100 in accordance with the present invention includes the infrared temperature sensor 1, the gas sensor 2 and the like sensor unit, and also the position-detecting element of the human-body infrared sensor 3, thus the disaster-sign factor in the controlled space can be detected. Then, the disaster-sign factor is provided to the management unit 53 for calculating the disaster precautious class and the pre-disaster-management regime by referring to pre-disaster alert classification rules of the disaster classification database 51. The corresponding pre-disaster-management reminder information is then forwarded to the warning module 6 and the wireless transmission module 4, so that the warning module 6 can alert users the possible management resorts in a verbal, light or wording manner.

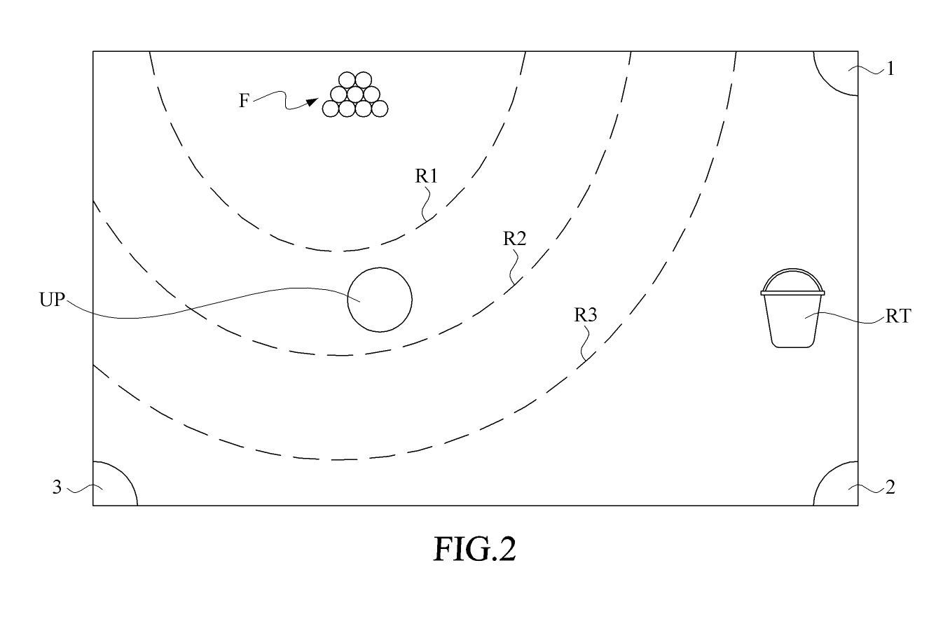

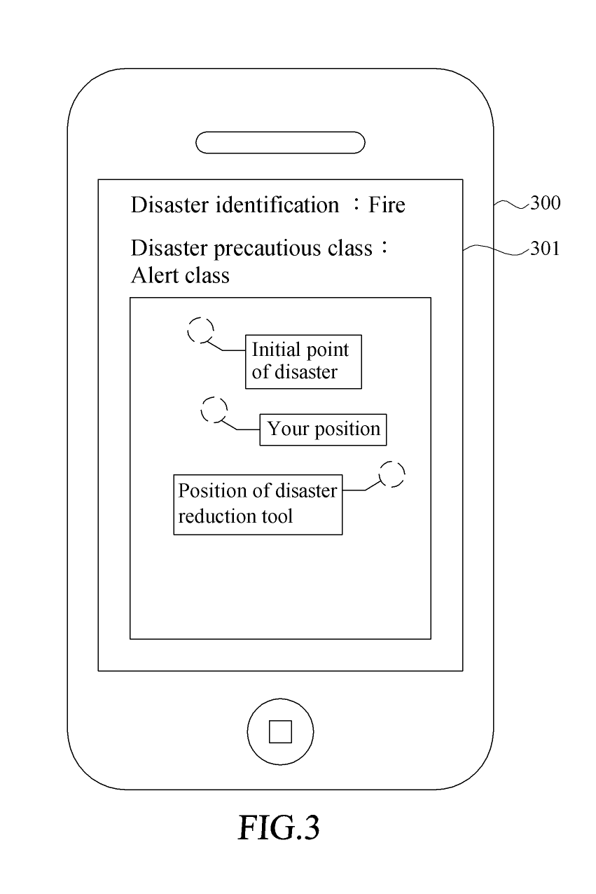

Refer now to FIG. 1 to FIG. 3; in which FIG. 2 demonstrates schematically the controlled space of the early-warning system for disasters for locating a user in accordance with the present invention, and FIG. 3 demonstrates schematically a display screen of a handheld device that shows the instant disaster-management reminder information. As shown, when the infrared temperature sensor 1 detects that, within the controlled space, the indoor temperature (T1) of a hi-risk point of fires F is greater than the Alert value t1 and the user position is P1, then the management unit 43 would base on the pre-disaster alert classification rules of the disaster classification database 41 to calculate and determine that the disaster class is a fire and the precautious class is an alert class. Thus, the management unit 43 would transmit the pre-disaster-management reminder information and the position of the disaster reduction tool RT in the disaster response database to the wireless transmission module 4 by an alert signal. The wireless transmission module 4, after receiving the alert signal, would forward the alert signal and the associated messages to the server 200 via the wireless network transmission unit 41, and further to the handheld device 300 via the server 200. Hence, the pre-disaster-management reminder information and the position of the disaster reduction tool RT can be displayed on the display screen 301 of the handheld device 300.

In addition, the disaster-managing regimes R1, R2 and R3 are determined by judging the occurrence times. Practically, for a fire at the hi-risk point of fires F, the disaster classification database 51 can provide these three disaster-managing regimes R1, R2 and R3. For example, when the disaster-managing regime R1 of the fire is defined as a distinguished regime, then the management unit 43 can still transmit the disaster-management reminder information to the wireless transmission module 4 so as further to forward the disaster-management reminder information to the handheld device 300 for notifying users the management means for the nearby disaster. However, when the fire is determined to be located within the disaster-managing regime R3 (disaster-already regime), the management unit 43 would advise users to escape immediately via the handheld device 300.

While the present invention has been particularly shown and described with reference to a preferred embodiment, it will be understood by those skilled in the art that various changes in form and detail may be without departing from the spirit and scope of the present invention.

What is claimed is:

1. An early-warning system for disasters, comprising:
at least one sensor unit, detecting at least one disaster-sign factor within a controlled space;
a person-position detection module, being to detect a user and then to generate a user position;
a primary control module, connected communicatively with the sensor unit and the person-position detection module, further including:
a disaster classification database, basing on the disaster-sign factor to set up at least one pre-disaster alert classification rule, further basing on the pre-disaster alert classification rule to define at least one pre-disaster-management regime;
a disaster response database, storing at least one pre-disaster-management reminder information corresponding to the pre-disaster alert classification rule and the pre-disaster-management regime; and
a management unit, electrically coupled with the disaster classification database and the disaster response database, issuing an alert signal including the pre-disaster-management reminder information after the user position is judged to be within the pre-disaster-management regime; and
a warning module, connected communicatively with the management unit so as to receive the alert signal and further to broadcast the pre-disaster-management reminder information.

2. The early-warning system for disasters of claim 1, wherein the disaster response database further stores positions of at least one disaster reduction tool.

3. The early-warning system for disasters of claim 2, wherein the disaster-management reminder information further includes the positions of at least one disaster reduction tool.

4. The early-warning system for disasters of claim 1, wherein the person-position detection module is a human-body infrared sensor for determining the user position by infrared-detecting a body temperature of the user.

5. The early-warning system for disasters of claim 1, wherein the person-position detection module is a wireless transmission module for detecting the user position of the user having a handheld device via a communicative positioning technique.

6. The early-warning system for disasters of claim 5, wherein the wireless transmission module includes a Bluetooth unit for detecting the user position of the user having the handheld device.

7. The early-warning system for disasters of claim 5, wherein the wireless transmission module includes a wireless network transmission unit connected communicatively with a server, the server detecting the user position of the user having the handheld device via a cellular-phone positioning technique.

8. The early-warning system for disasters of claim 5, wherein the wireless transmission module is to further transmit the alert signal to a server for the server to transmit the alert signal to the handheld device so as to broadcast the pre-disaster-management reminder information in a word message manner.

9. The early-warning system for disasters of claim 1, wherein the warning module further includes a warning message unit for broadcasting verbally the pre-disaster-management reminder information.

10. The early-warning system for disasters of claim 1, wherein the pre-disaster-management reminder information further includes management time limits of pre-disaster alert class.
